(19) United States
(12) Patent Application Publication
(10) Pub. No.: US 2022/0172735 A1
(43) Pub. Date: Jun. 2, 2022

(54) METHOD AND SYSTEM FOR SPEECH SEPARATION

(71) Applicant: HARMAN INTERNATIONAL INDUSTRIES, INCORPORATED, Stamford, CT (US)

(72) Inventors: Xiangru BI, Xuhui District Shanghai (CN); Qingshan ZHANG, Xuhui District Shanghai (CN)

(73) Assignee: HARMAN INTERNATIONAL INDUSTRIES, INCORPORATED, Stamford, CT (US)

(21) Appl. No.: 17/436,050

(22) PCT Filed: Mar. 7, 2019
(86) PCT No.: PCT/CN2019/077321

§ 371 Date: Sep. 2, 2021

(51) Int. Cl. G10L 21/0272; G10L 25/45; G10L 25/87; G10L 25/90

(52) U.S. Cl. CPC G10L 21/0272; G10L 25/90; G10L 25/87; G10L 25/45

(57) ABSTRACT

The present disclosure is directed to a speech separation method and system using a sliding window. The method comprises: acquiring at least one speech from at least one user by at least one microphone and storing the at least one speech as a speech signal in a sound recording module; extracting the speech signal from the sound recording module and processing the extracted speech signal through a sliding window; and transmitting the processed speech signal to a Degenerate Unmixing Estimation Technique (DUET) module for speech separation.

### CROSS-REFERENCE TO RELATED APPLICATIONS

This application claims priority to PCT Patent Application No. PCT/CN2019/077321, filed Mar. 7, 2019, and entitled “METHOD AND SYSTEM FOR SPEECH SEPARATION”, the entire disclosure of which is incorporated herein by reference.

### TECHINICAL FIELD

The present invention relates to a system for speech separation and a method performed in the system, and specifically relates to a system and a method for improving speech separation performance by a sliding window.

### BACKGROUND

In recent years, more and more vehicles have voice recognition functions. However, when more than one person speaks in the vehicle at the same time, the host of the vehicle will not be able to quickly recognize the sound from the driver from a plurality of voices. In this case, the corresponding operation cannot be performed according to the driver's instruction accurately and promptly, and it is easy to cause an erroneous operation.

Currently, there are mainly two ways to perform speech separation. The first is to create a microphone array for voice enhancement. The second is to use algorithms for speech separation. Various algorithms for speech separation may include Frequency Domain Independent Component Analysis (FDICA), Degenerate Unmixing Estimation Technique (DUET) or their extension algorithms.

A DUET Blind Source Separation method can separate any number of voice sources using only two mixtures. The method is valid when sources are W-disjoint orthogonal, that is, when the supports of the windowed Fourier transform of the signals in the mixture are disjoint. For anechoic mixtures of attenuated and delayed sources, the method allows one to estimate the mixing parameters by clustering relative attenuation-delay pairs extracted from the ratios of the time-frequency representations of the mixtures. The estimates of the mixing parameters are then used to partition the time-frequency representation of one mixture to recover the original sources.

FIG. 1 illustrates a conventional speech separation system which comprises two microphones, a sound recording module and a DUET module. For example, two microphones are first opened at the same time so that the two microphones start recording. When two people start talking, a sound recording module is responsible for receiving and storing the speech signal from the two microphones. In the example shown in FIG. 1, a first sound (sound1) belongs to a first person (person1) and a second sound (sound2) belongs to a second person (person2). The DUET module receives a signal from the sound recording module, then analyses and separates the signal to recover the original sources of sounds.

In practice, for example, if the time of a segment of speech is 4 seconds (such as shown in FIG. 2 (a)), the DUET module will process the segments of 4 seconds speech directly. Due to the complexity of the DUET algorithm, it will take a long time to process the voice data. Usually, voice signals are sparse, and a large amount of information is concentrated in a very short period of time. Most of the time, there is no voice signal in the received signals. However, the DUET module still waits for a period of time (such as the entire segment of speech, 4s) and takes a long time to process the received signals due to the complexity of the DUET algorithm.

Therefore, there is a need to develop an improved speech separation system and method that can quickly perform the speech separation so as to quickly recover the original sources of sounds.

### SUMMARY

In one or more illustrative embodiments, a method for speech separation is provided. The method uses at least one microphone to acquire at least one speech from at least one user and stores the at least one speech as a speech signal in a sound recording module. The method further extracts the speech signal from the sound recording module and processes the extracted speech signal through a sliding window, and transmits the processed speech signal to a DUET module for speech separation.

Preferably, the method in one embodiment uses a sliding window by traversing the extracted speech signal to determine a maximum amplitude of the speech signal; determining a starting position of the sliding window, the starting position of the sliding window is a position where the amplitude of the speech signal exceeds a predetermined proportion of the maximum amplitude for the first time from the beginning of the speech signal; determining an ending position of the sliding window, the ending position of the sliding window is a position where the amplitude of the speech signal exceeds a predetermined proportion of the maximum amplitude for the first time from the ending of the speech signal back to the beginning of the speech signal; and selecting the segment of the speech signal between the start position of the sliding window and the ending position of the sliding window as a processed speech signal for speech separation.

Preferably, the method in another embodiment uses a sliding window by traversing the extracted speech signal to determine an average amplitude of the speech signal; determining a starting position of the sliding window, the starting position of the sliding window is a position where the amplitude of the speech signal exceeds the average amplitude for the first time from the beginning of the speech signal; determining an ending position of the sliding window, the ending position of the sliding window is a position where the amplitude of the speech signal exceeds the average amplitude for the first time from the ending of the speech signal back to the beginning of the speech signal; selecting the segment of the speech signal between the start position of the sliding window and the ending position of the sliding window as a processed speech signal for speech separation.

In one or more illustrative embodiments, a system for speech separation is provided. The system for speech separation comprises at least one microphone for acquiring at least one speech from at least one user, a sound recording module for storing the at least one speech as a speech signal, a sliding window for extracting the speech signal from the sound recording module and processing the extracted speech signal, and a DUET module for receiving the processed speech signal to for speech separation.

Preferably, the sliding window in one embodiment is configured to traverse the extracted speech signal to determine a maximum amplitude of the speech signal; determine a starting position of the sliding window, the starting position of the sliding window is a position where the amplitude of the speech signal exceeds a predetermined proportion of the maximum amplitude for the first time from the beginning of the speech signal; determine an ending position of the sliding window, the ending position of the sliding window is a position where the amplitude of the speech signal exceeds a predetermined proportion of the maximum amplitude for the first time from the ending of the speech signal back to the beginning of the speech signal; and select the segment of the speech signal between the start position of the sliding window and the ending position of the sliding window as a processed speech signal for speech separation.

Preferably, the sliding window in another embodiment is configured to traverse the extracted speech signal to determine an average amplitude of the speech signal; determine a starting position of the sliding window, the starting position of the sliding window is a position where the amplitude of the speech signal exceeds the average amplitude for the first time from the beginning of the speech signal; determine an ending position of the sliding window, the ending position of the sliding window is a position where the amplitude of the speech signal exceeds the average amplitude for the first time from the ending of the speech signal back to the beginning of the speech signal; select the segment of the speech signal between the start position of the sliding window and the ending position of the sliding window as a processed speech signal for speech separation.

A computer readable media having computer-executable instructions for performing the abovesaid method is provided.

Advantageously, the disclosed speech separation system and method can improve the real time performance of DUET by using a sliding window.

The systems, methods, features and advantages will be, or will become, apparent to one with skill in the art upon examination of the following figures and detailed description. It is intended that all such additional systems, methods, features and advantages be included within this description, be within the scope of the invention.

### BRIEF DESCRIPTION OF THE DRAWINGS

The features, nature, and advantages of the present application may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram of a conventional speech separation system.

FIG. 2 illustrates a schematic diagram of a speech separation system in accordance with one embodiment of the present invention.

FIG. 3 schematically illustrates a sliding window used in the speech separation system in accordance with one embodiment of the present invention.

FIG. 4 schematically illustrates a sliding window used in the speech separation system in accordance with another embodiment of the present invention.

FIG. 5 illustrates a flow chat of the speech separation method according to one embodiment of the present invention.

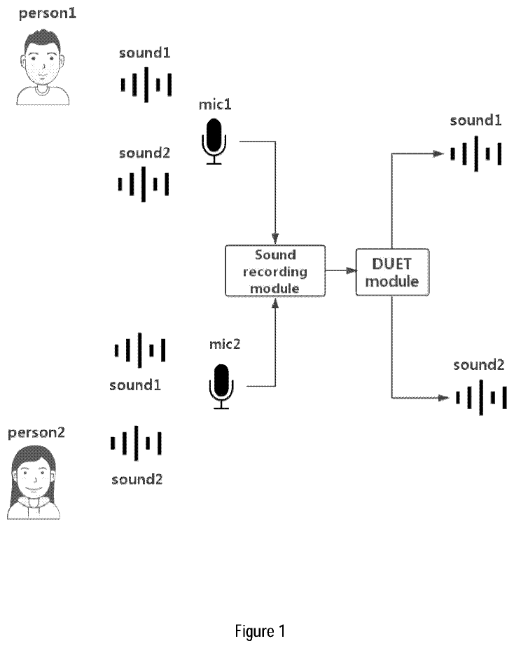

### DETAILED DESCRIPTION

It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. One or more functional blocks or units may also be implemented in a common circuit, chip, circuit element or unit.

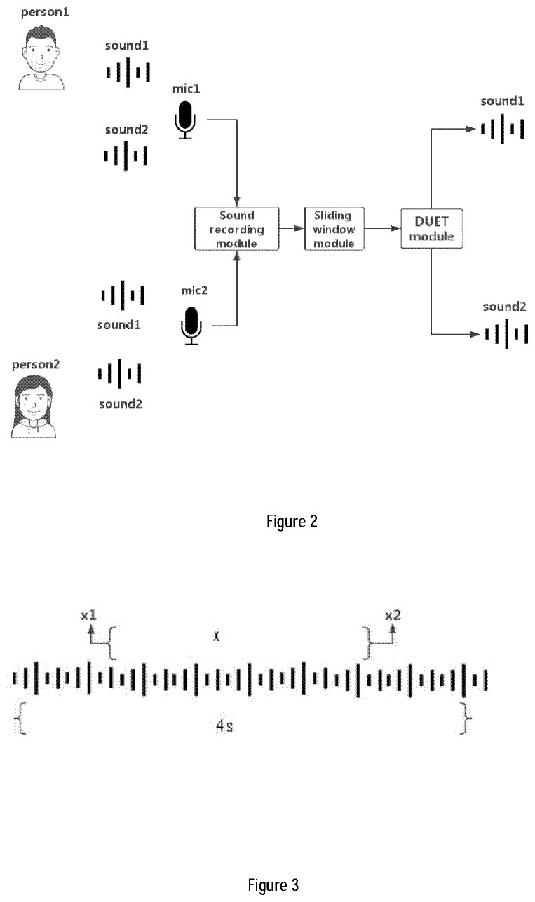

FIG. 2 illustrates a schematic diagram of a speech separation system in accordance with one embodiment of the present invention. The speech separation system can be used in a vehicle and may comprise at least one microphone, a sound recording module, a sliding window module and a DUET module. For ease of explanation, FIG. 2 only shows two microphones (mic1 and mic2) and two people (person1 and person2), but those skilled in the art can understand the system may comprise more microphones. The two microphones may acquire at least one speech from at least one user. FIG. 2 shows two persons as an example. For example, the two persons may be a driver and a passenger.

When the system is working, for example, as shown in FIG. 2, each of the two microphones acquires the speeches from the two persons. For example, the first microphone (mic1) can collect the first speech (sound1) from the first person and the second speech (sound2) from the second person, and then transmit them to the sound recording module for recording as a speech signal which mixes the information from the two sound sources. Also, the second microphone (mic1) can collect the first speech (sound1) from the first person and the second speech (sound2) from the second person, and then transmit them to the sound recording module for recording as a speech signal which includes the information from the two sound sources.

The sliding window module can extract the speech signal from the sound recording module and processes the extracted speech signal by a sliding window. The processed speech signal is then transmitted to a DUET module for speech separation. At last, the different sources of speech can be separated. For example, the processed speech signal can be finally separated into the first speech (sound1) from the first person and the second speech (sound2) from the second person.

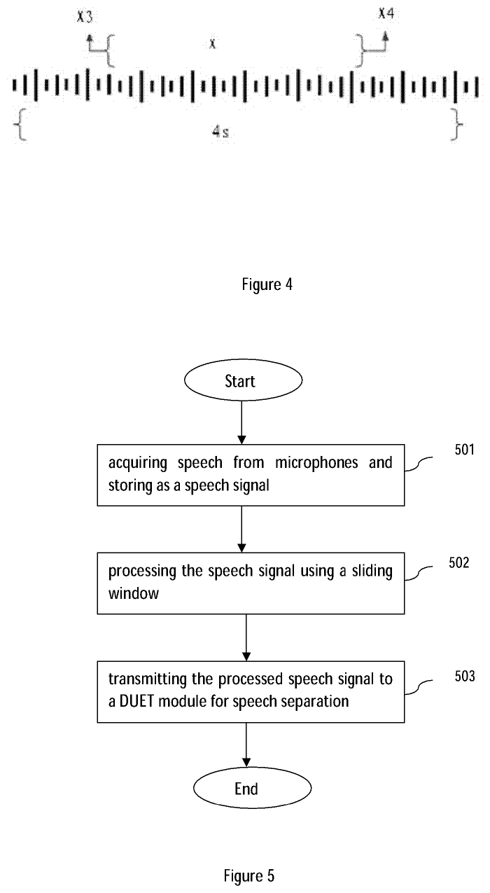

A sliding window will be illustrated referring to FIG. 3 and FIG. 4. FIG. 3 schematically illustrates a sliding window used in the speech separation system in accordance with one embodiment of the present invention.

For example, the extracted speech signal may last four seconds as shown in FIG. 3. First, the extracted speech signal is traversed to determine a maximum amplitude of the speech signal. Then, a starting position of the sliding window and an ending position of the sliding window will be determined. From the beginning of the speech signal, a point (such as, point X1 as showed in FIG. 3) is found. At point X1, the amplitude of the speech signal exceeds a predetermined proportion of the maximum amplitude for the first time. Preferably, the predetermined proportion may be greater than or equal to ¼ and less than or equal to ½. Then, this point X1 is determined as the starting position of the sliding window. Next, from the ending of the speech signal to the beginning of the speech signal, a point (such as, point X2 as showed in FIG. 3) is found. At point X2, the amplitude of the speech signal exceeds the predetermined proportion of the maximum amplitude for the first time from the ending of the speech signal. Then, this point X2 is determined as the ending position of the sliding window. A window length of the sliding window can be determined based on the starting position of the sliding window and the ending position of the sliding window, i.e., the window length is equal to X2-X1 (as x shown in FIG. 3). Next, the segment of the speech signal between the start position and the ending position of the sliding window (i.e., the segment within the sliding window) is selected as a processed speech signal and is sent to the DUET for speech separation.

FIG. 4 schematically illustrates a sliding window used in the speech separation system in accordance with another embodiment of the present invention.

For example, FIG. 4 shows the extracted speech signal which may also lasts four seconds. First, an average amplitude of the speech signal is determined by traversing the extracted speech signal. Then, a starting position of the sliding window and an ending position of the sliding window will be determined. From the beginning of the speech signal, a point (such as, point X3 as showed in FIG. 4) is found. At point X3, the amplitude of the speech signal exceeds the average amplitude of the speech signal for the first time. Then, this point X3 is determined as the starting position of the sliding window. Next, from the ending of the speech signal to the beginning of the speech signal, a point (such as, point X4 as showed in FIG. 4) is found. At point X4, the amplitude of the speech signal exceeds the average amplitude for the first time from the ending of the speech signal. Then, this point X4 is determined as the ending position of the sliding window. A window length of the sliding window can be determined based on the starting position of the sliding window and the ending position of the sliding window, i.e., the window length is equal to X4-X3 (as x shown in FIG. 4). Next, the segment of the speech signal between the start position and the ending position of the sliding window (i.e., the segment within the sliding window) is selected as a processed speech signal and is sent to the DUET for speech separation.

FIG. 5 illustrates a flow chat of the speech separation method according to one embodiment of the present invention.

As shown in FIG. 5, at step 501, at least one speech from at least one user is acquired by at least one microphone and then is stored as a speech signal in a sound recording module. At step 502, the speech signal transmitted from the sound recording module is further processed using a sliding window before it is sent to a DUET module for speech separation. At step 503, the processed speech signal is transmitted to the DUET module.

The processing using a sliding window at step 502 may comprise determining a window length of a sliding window, and selecting a segment of the speech signal within the window length of the sliding window as the processed speech signal for further speech separation.

According to one embodiment of the present invention, determining a window length of a sliding window may comprise traversing the extracted speech signal to determine a maximum amplitude of the speech signal. Then, a starting position of the sliding window and an ending position of the sliding window are determined to obtain the window length of the sliding window. The starting position of the sliding window is a position where the amplitude of the speech signal exceeds a predetermined proportion of the maximum amplitude for the first time from the beginning of the speech signal. The ending position of the sliding window is a position where the amplitude of the speech signal exceeds a predetermined proportion of the maximum amplitude for the first time from the ending of the speech signal back to the beginning of the speech signal. Preferably, the predetermined proportion may be greater than or equal to ¼ and less than or equal to ½.

According to another embodiment of the present invention, determining a window length of a sliding window may comprises traversing the extracted speech signal to determine an average amplitude of the speech signal. Then, a starting position of the sliding window and an ending position of the sliding window are determined to obtain the window length of the sliding window. For example, the starting position of the sliding window is a position where the amplitude of the speech signal exceeds the average amplitude for the first time from the beginning of the speech signal. The ending position of the sliding window is a position where the amplitude of the speech signal exceeds the average amplitude for the first time from the ending of the speech signal back to the beginning of the speech signal.

The speech separation method and system of the present invention introduces a sliding window to pre-process data before sending the data collected by the microphone to the DUET module for processing. By extracting the relatively concentrated portion of the speech information in a segment of the signal and removing unnecessary portions of the segment signal, the amount of data that the DUET algorithm needs to process is reduced, thereby reducing the running time of the DUET algorithm, thereby improving the work efficiency of the overall speech separation system.

The term “module” may be defined to include a plurality of executable modules. The modules may include software, hardware, firmware, or some combination thereof executable by a processor. Software modules may include instructions stored in memory, or another memory device, that may be executable by the processor or other processor. Hardware modules may include various devices, components, circuits, gates, circuit boards, and the like that are executable, directed, or controlled for performance by the processor.

The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims.

1. A method for speech separation, comprising:
acquiring at least one speech from at least one user by at least one microphone and storing the at least one speech as a speech signal in a sound recording module;
extracting the speech signal from the sound recording module and processing the extracted speech signal through a sliding window; and
transmitting the processed speech signal to a Degenerate Unmixing Estimation Technique (DUET) module for speech separation.

2. The method of claim 1, wherein processing the extracted speech signal through the sliding window comprising:
traversing the extracted speech signal to determine a maximum amplitude of the speech signal; and
determining a starting position of the sliding window, the starting position of the sliding window is a position where an amplitude of the speech signal exceeds a predetermined proportion of the maximum amplitude for a first time from a beginning of the speech signal.

3. (canceled)

4. (canceled)

5. (canceled)

6. (canceled)

7. (canceled)

8. (canceled)

9. (canceled)

10. The method of claim 2, wherein processing the extracted speech signal through the sliding window further comprises:
determining an ending position of the sliding window, the ending position of the sliding window is a position where the amplitude of the speech signal exceeds a predetermined proportion of the maximum amplitude for the first time from the ending of the speech signal back to the beginning of the speech signal; and
selecting a segment of the speech signal between the start position of the sliding window and the ending position of the sliding window as the processed speech signal for speech separation.

11. The method according to claim 10, wherein the predetermined proportion is greater than or equal to ¼ and less than or equal to ½.

12. The method of claim 1, wherein processing the extracted speech signal through the sliding window comprising:
traversing the extracted speech signal to determine an average amplitude of the speech signal; and
determining a starting position of the sliding window, the starting position of the sliding window is a position where an amplitude of the speech signal exceeds the average amplitude for a first time from a beginning of the speech signal.

13. The method of claim 12, wherein processing the extracted speech signal through the sliding window further comprises:
determining an ending position of the sliding window, the ending position of the sliding window is a position where the amplitude of the speech signal exceeds the average amplitude for the first time from the ending of the speech signal back to the beginning of the speech signal; and
selecting a segment of the speech signal between the start position of the sliding window and the ending position of the sliding window as the processed speech signal for speech separation.

14. A system for speech separation, comprising:
at least one microphone for acquiring at least one speech from at least one user;
a sound recording module for storing the at least one speech as a speech signal;
a sliding window for extracting the speech signal from the sound recording module and processing the extracted speech signal; and
a Degenerate Unmixing Estimation Technique (DUET) module for receiving the processed speech signal to for speech separation.

15. The system according to claim 14, wherein the sliding window is further configured to:
traverse the extracted speech signal to determine a maximum amplitude of the speech signal; and
determine a starting position of the sliding window, the starting position of the sliding window is a position where an amplitude of the speech signal exceeds a predetermined proportion of the maximum amplitude for a first time from a beginning of the speech signal.

16. The system according to claim 15, wherein the sliding window is further configured to:
determine an ending position of the sliding window, the ending position of the sliding window is a position where the amplitude of the speech signal exceeds a predetermined proportion of the maximum amplitude for the first time from the ending of the speech signal back to the beginning of the speech signal; and
select a segment of the speech signal between the start position of the sliding window and the ending position of the sliding window as the processed speech signal for speech separation.

17. The system according to claim 16, wherein the predetermined proportion is greater than or equal to ¼ and less than or equal to ½.

18. The system according to claim 14, wherein the sliding window is further configured to:
traverse the extracted speech signal to determine an average amplitude of the speech signal; and
determine a starting position of the sliding window, the starting position of the sliding window is a position where an amplitude of the speech signal exceeds the average amplitude for a first time from a beginning of the speech signal.

19. The system according to claim 18, wherein the sliding window is further configured to:
determine an ending position of the sliding window, the ending position of the sliding window is a position where the amplitude of the speech signal exceeds the average amplitude for the first time from the ending of the speech signal back to the beginning of the speech signal; and
select a segment of the speech signal between the start position of the sliding window and the ending position of the sliding window as the processed speech signal for speech separation.

20. A computer-program product embodied in a non-transitory computer read-able medium that is programmed for performing speech separation, the computer-program product comprising instructions for:
acquiring at least one speech from at least one user by at least one microphone and storing the at least one speech as a speech signal in a sound recording module;
extracting the speech signal from the sound recording module and processing the extracted speech signal through a sliding window; and
transmitting the processed speech signal to a Degenerate Unmixing Estimation Technique (DUET) module for speech separation.

21. The computer-program product of claim 20, wherein processing the extracted speech signal through the sliding window comprising:
traversing the extracted speech signal to determine a maximum amplitude of the speech signal; and
determining a starting position of the sliding window, the starting position of the sliding window is a position where an amplitude of the speech signal exceeds a predetermined proportion of the maximum amplitude for a first time from a beginning of the speech signal.

22. The computer-program product of claim 21, wherein processing the extracted speech signal through the sliding window further comprises:
determining an ending position of the sliding window, the ending position of the sliding window is a position where the amplitude of the speech signal exceeds a predetermined proportion of the maximum amplitude for the first time from the ending of the speech signal back to the beginning of the speech signal; and
selecting a segment of the speech signal between the start position of the sliding window and the ending position of the sliding window as the processed speech signal for speech separation.

23. The computer-program product of claim 22, wherein the predetermined proportion is greater than or equal to ¼ and less than or equal to ½.

24. The computer-program product of claim 20, wherein processing the extracted speech signal through the sliding window comprising:
traversing the extracted speech signal to determine an average amplitude of the speech signal; and
determining a starting position of the sliding window, the starting position of the sliding window is a position where an amplitude of the speech signal exceeds the average amplitude for a first time from a beginning of the speech signal.

25. The computer-program product of claim 24, wherein processing the extracted speech signal through the sliding window further comprises:
determining an ending position of the sliding window, the ending position of the sliding window is a position where the amplitude of the speech signal exceeds the average amplitude for the first time from the ending of the speech signal back to the beginning of the speech signal; and
selecting a segment of the speech signal between the start position of the sliding window and the ending position of the sliding window as the processed speech signal for speech separation.
